(19) United States
(12) Patent Application Publication
(10) Pub. No.: US 2002/0073326 A1
(43) Pub. Date: Jun. 13, 2002

(54) Protect by data chunk address as encryption key

(76) Inventor: Wilhelmus Franciscus Johannes Fontijn, Eindhoven (NL)

Correspondence Address: Corporate Patemt Counsel, U.S. Philips Corporation, 580 White Plains Road, Tarrytown, NY, 10591, US

(21) Appl. No.: 09/950,463

(22) Filed: Sep. 10, 2001

(30) Foreign Application Priority Data
Sep. 15, 2000 (EP) 00203207.6

(51) Int. Cl. H04L 9/00

(52) U.S. Cl. 713/190

(57) ABSTRACT

A computer operates on confidential data that are organized in finite-sized data chunks. First, each said data chunk is assigned a particular logical address of a set of logical addresses. Next, each data chunk is stored at a respective unique physical address on a medium, while maintaining a predetermined relationship between the particular logical address and the unique physical address. Next, a computer software program accesses the chunks through the logical addresses. A representation of predetermined relationship is read. In particular, before storing, a data chunk is encrypted through an encryption key that is at least co-based on an address assigned to the data chunk. After reading, a data chunk is decrypted through usage of a decryption key as an inverse of the latter encryption key. The chunks may or may not be uniform-sized.

### BACKGROUND OF THE INVETION

The invention relates to a computer method for operating confidential data that are organized in finite-sized data chunks. Many files of confidential data should have access thereto and/or dissemination thereof limited to restricted situations and/or particular parties only. Various schemes for conserving such confidentiality have been proposed, and often a trade-off will be applied between the robustness of the protection scheme and the cost incurred through implementation thereof, such as incurred both during the providing of the original protection, and also at the time when the protected information is being used by an entity entitled to do so. A particular protective policy has been proposed in U.S. Pat. No. 5,661,800 to Nakashima et al, and assigned to Fujitsu Limited, such encompassing:

a computer method for operating confidential data that are organized in uniform-sized data chunks, and comprising the steps of:

assigning to each data chunk a particular logical address of a set of logical addresses;

storing each data chunk at a respective unique physical address on a medium, whilst maintaining a predetermined relationship between its particular logical address and the unique physical address;

executing a computer software program that accesses the chunks through the logical addresses;

reading a representation of the predetermined relationship;

checking occurrence of the physical addresses as being paired to associated logical addresses for conformance to the predetermined relationship as being read; and

on the basis of an outcome of the checking, accepting or rejecting the instant medium as an authorized version or otherwise.

Now often, the straight translating between logical address and physical address is overly transparent to a user, so that the protection may be broken easily by a malevolent receiver of the information. In contradistinction, the present inventor has recognized that using the address as a means for also influencing the representation inside the data chunk will offer a degree of protection that is invariably much higher, while nevertheless keeping the decoding complexity for an authorized user at an acceptable level as regarding costs, delay, and the like.

### SUMMARY TO THE INVENTION

In consequence, amongst other things, it is an object of the present invention to use the actual address of protected data as a means for raising the level of protection regarding decoding complexity to an unauthorized user to an adequate level for so effecting a sufficient degree of security, while keeping decoding by an authorized user relatively straightforward, once the decoding key has become available.

Now therefore, according to one of its aspects the invention is characterized according to the recitation presented in claim 1. In particular, one of the applications of the present invention can be the secure storage of digital content on a purely consumer electronics based platform, thus explicitly without the use of any general computer system, and/or in an environment that is principally intended for use by non-professional persons. Furthermore, the check on the correct pairing of physical and logical sectors as recited in the reference could represent a valuable further raising of the security level of the present invention. However, not every implementation is expected to use this feature.

The invention also relates to apparatus arranged for implementing the method according to claim 1, and to a data carrier carrying a set of protected data chunks for being used in the method as claimed in claim 1, and by themselves being claimed in independent claims 9, 16, 17 and 18, respectively. Further advantageous aspects of the invention are recited in dependent claims.

### BRIEF DESCRIPTION OF THE DRAWING

These and further aspects and advantages of the invention will be discussed more in detail hereinafter with reference to the disclosure of preferred embodiments, and in particular with reference to the appended Figures that show:

FIG. 1, a general computer-based processing system for operating data;

FIGS. 2a, 2b illustrate the basic process use of the encryption lock;

FIGS. 3a, 3b illustrate secured and unsecured relocation of a locked file;

FIGS. 4a, 4b illustrate a replay attack and various remedies theregainst;

FIG. 5 illustrates secured transport of the protected data on an internet facility;

FIG. 6 illustrates secure storage of protected data retrieved from an internet facility.

### DETAILED DESCRIPTION OF PREFERRED EMBODIMENTS

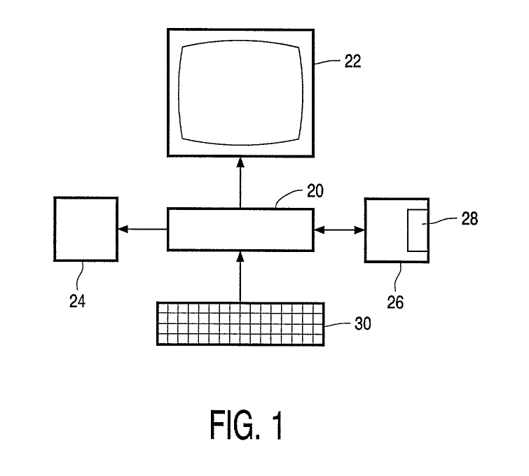

FIG. 1 illustrates a general computer-based processing system for operating data. Centered around a central processing unit such as a personal computer 20 or a dedicated special purpose processor in a consumer-electronics oriented device are an image display subsystem 22, an optional printer subsystem 24, a data storage subsystem 26, such as having berth means for introducing an optically or magnetically readable physical mass medium or data carrier 28, and a keyboard or other manual entry subsystem 30. The optical or magnetical mass storage medium may in fact carry the protected information for being decoded in the user apparatus shown in FIG. 1, and the protected information or data thereon may or may not be accompanied by the program or by a part thereof that will use the protected data. In its turn, the program itself may be protected by other means that need not form part of the invention, so that without further measures, the combination cannot fully be operated by an environment that is not fully entitled to do so.

In the arrangement, various possible further facilities have not been shown for brevity but may be added for enhancing functionality, such as speech control, audio output, mouse, internet or other remote data presentation facilities, and external hardware that is actuator-controlled by the data processing system and which can present sensor or other feedback information as regarding its operation. The prime functionality of the system may be consumer audio/video rendering, data processing of a more general character, games, and other.

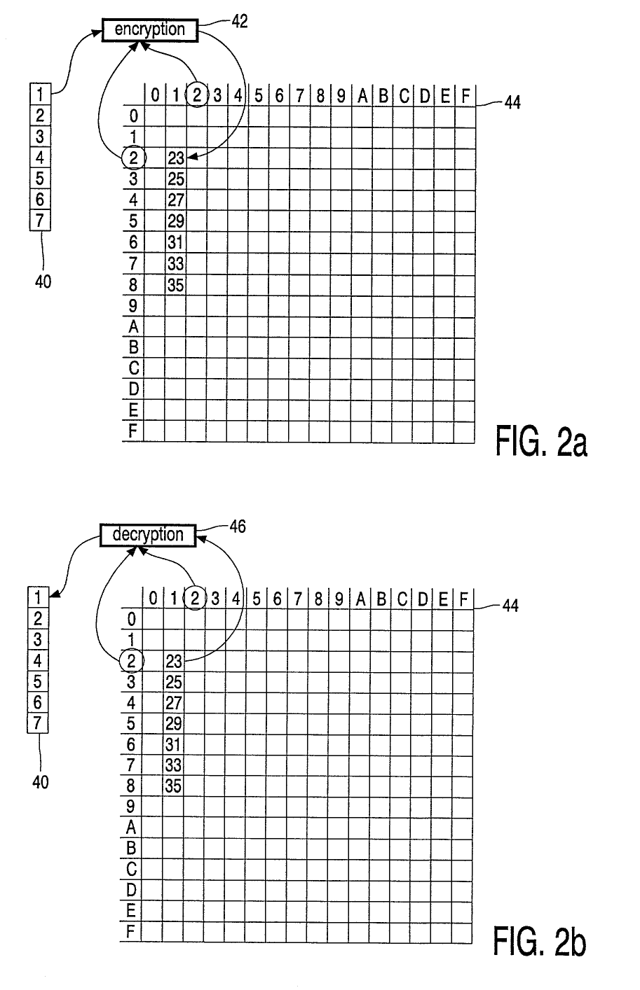

FIGS. 2a, 2b illustrate the basic process use of the encryption lock according to the present invention. A data file 40, consisting of data sectors 1 through 7, is to be stored in a storage array 44 that by way of example has bidimensional physical address ranges both running from hex0 through hexF. For encrypting of a particular sector, that here represents an individual chunk of data, its physical address is retrieved, fed to an encryption subsystem 42 that uses the address in question for including it into an encryption key for therewith executing an encryption process, and after encryption, the sector is stored as one of stored data sectors 23 through 35. The latter numerals have been changed with respect to those of the original file 40, for so symbolizing the influence of the encrypting on the content of the encrypted data chunk. By itself, encryption processes have been in wide use, both scientifically and commercially, such as being based for example on the RSA and DES algorithms, and further detailing of such processes has been left out for brevity. Upon reading the data, the original physical address is retrieved, as well as the encrypted data sectors, the latter are then decrypted by using the inverse of the original encryption process in decrypting subsystem 46 and presented for use as original data file 40. Note that the whole sector, or rather only a critical part thereof, and/or only only a limited selection amongst all of the sectors comprising a file may be encrypted. Note that the encrypted data chunks may have mutually uniform sizes, but this is not an explicit requirement of all embodiments of the present invention.

Various amendments to the above are feasible. In the first place, the computer program to which the data chunks are associated, may present the logical addresses of the data chunks instead of their physical addresses for immediate application for the encoding key. In fact, the physical address of the data chunk is generally found through a straightforward logical-to-physical address translation. Next, a combination of various, and in particular, non-contiguous physical addresses may be used for collectively constituting or causing part of a single composite encryption key. Third, other and possibly secret encryption keys and/or methods may be combined with the above into a single composite encryption operation. Further, another address than the physical address itself may be used, such as an incremented or decremented physical address, or another address that in a causal and predictable manner relates to the actual physical or logical address.

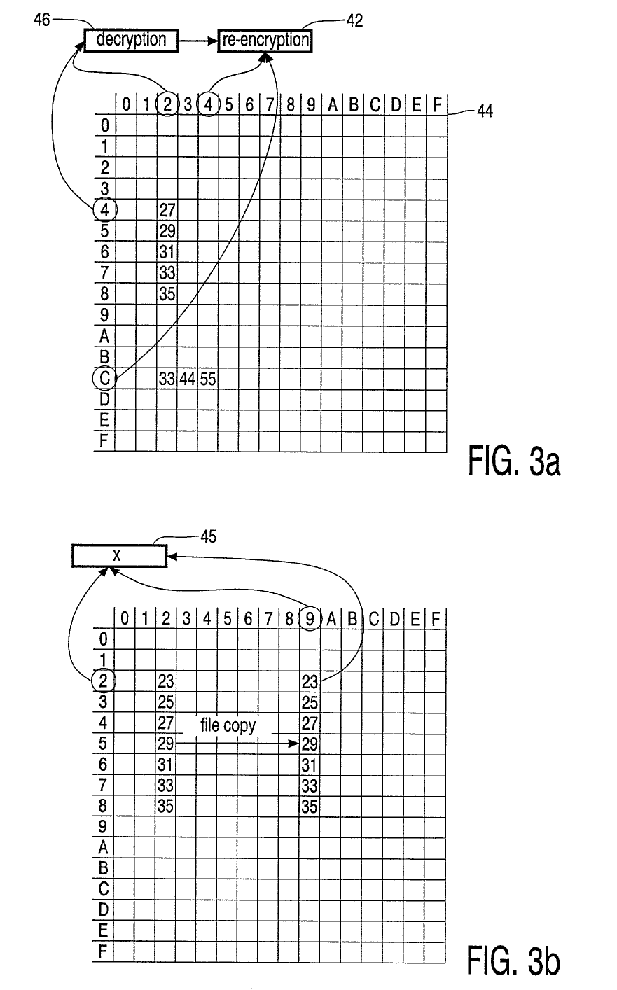

To access the encrypted data, the application or computer program must be aware of the address-based encryption lock. Such application would be a trusted application for ensuring that only legitimate copying and/or moving of the protected data can take place. Therefore, the application must check that it has indeed been given authority to execute such copying or moving, such as by a copy generation management organization, so that it will be able to retrieve the decryption key or keys. In this ambit, FIGS. 3a, 3b illustrate secured and unsecured locked file relocation, respectively. In FIG. 3a, the file as shown in FIG. 2b is again decrypted in subsystem 46, followed by a further encryption in encryption subsystem 42, be it on the basis of an amended set of physical addresses. Such is symbolized by representing the relocated data sectors as having a different information content by further changing the associated numerals. FIG. 3b in contrast illustrates unsecured relocation, by which the stored information, even if decryption will be undertaken by decryption subsystem 45, may have lost a significant part of its content. Of course, if the encryption key was the logical address, the amended physical address is only based on amending the logical-to-physical address translation, and the eventual information remains the same.

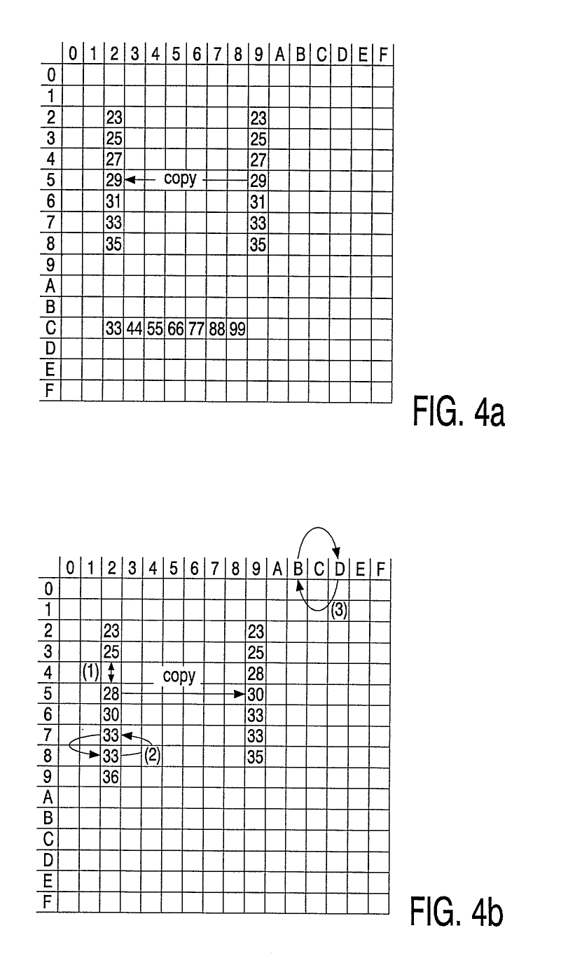

FIGS. 4a, 4b illustrate a replay attack and various remedies theregainst. Now, a replay attack by an unauthorized entity can proceed as follows. First it will copy, as in FIG. 4a, the encrypted file shown in FIG. 3b, to another location, according to some feasible copying or transfer mechanism, while also retaining the original encrypted information. Next, it will move the original encrypted information securely as shown in FIG. 3a. Finally, it will copy the transferred version back to the original location. In this manner, there will now be two correctly encrypted versions available of the original information. The original embodiment of FIG. 2 by itself does not protect against this scheme, so that additional measures would appear desirable.

An adequate solution is proposed by FIG. 4b. Herein, the trusted application that writes the data sectors, will control which physical sectors will be used and/or in what sequence. Case (1) will skip a sector, whereas case (2) interchanges two sectors. The making of a straightforward copy of the file will undo these amendments, but the encryption remains based on the original physical adresses, so that subsequent decrypting will present results that are partly or fully unusable. In the case of authored media, the sequencing of mapping the logical addresses on the physical can be changed such as in case (3). Various further such measures would appear to the skilled art person while not exceeding the scope of the appended claims, such as storing the first sector address with the secret key, combining it with the secret key, and keeping an encrypted table of first sector addresses.

Another proposed mechanism is that of sparing, which means that if for some reason a particular sector becomes unreadable, the drive apparatus will transparently assign another physical sector to the logical sector address that was used up to then for the now unreadable sector. If the logical address of the chunk is used to encrypt the data under the principles of the present invention, no real breakdown occurs. If on the other hand, the physical address is used, additional measures must be taken to maintain the encrypted file readable. On the other hand, if the above recited sparing mechanism is available to the trusted application itself, this feature may further raise the degree of protection by influencing the the mapping of the logical sectors on the physical sectors.

Note that the above proposed scheme by itself does not protect against bit-copy attacks, which would make its prime field of application mass storage devices. As regarding removable storage media however, these would by themselves vulnerable to a bit-copy attack, and in consequence, additional measures, such as the use of a unique medium identifier, would be required to achieve adequate data protection. The latter feature could readily be combined with the teachings of the present invention.

Concluding, the present invention proposes to let each sector have its own set of decryption keys, so that in particular, there is no overall useable key. Notably, the rapid changes from key to key will highly tax any decryption methods that operate by trial and error, whereas trusted software will have the keys extremely readily available. Note also that access to an external decryption key will still not make the content freely available, because both the external key itself and also the manner in which it must be combined with the sector address in the encryption/decryption algorithm must be reproduced, which in fact boils down to having to rebuild the entire trusted application.

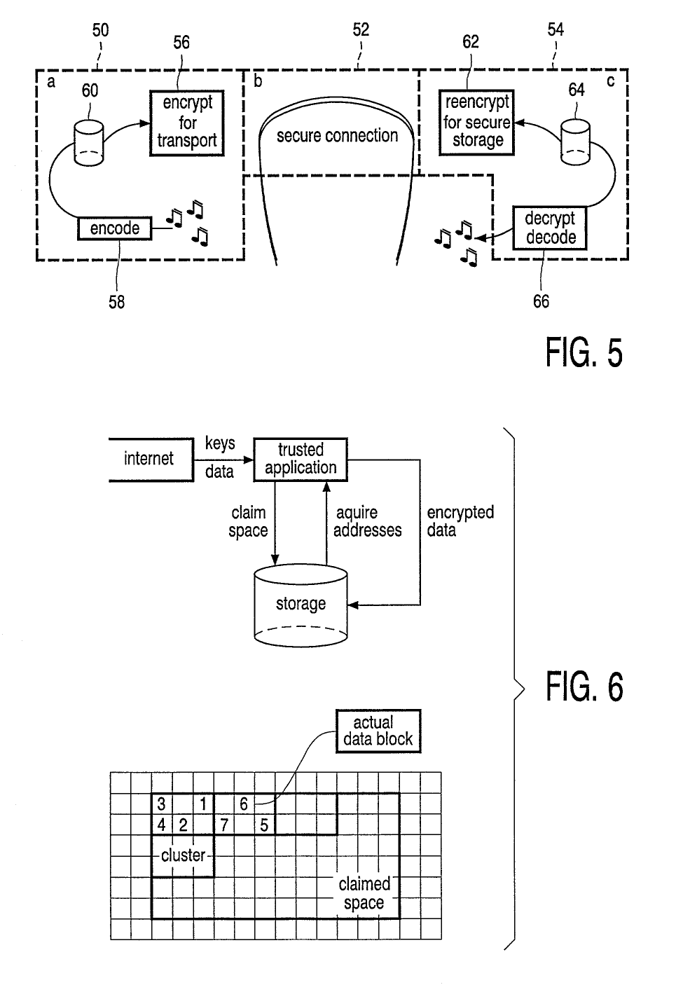

Now, by way of an exemplary embodiment, FIG. 5 illustrates secured transport of the protected audio data on an Internet facility. First, the server side 50 of control may be an Internet Portal of a Record Label, used to distribute audio content, which has been symbolized by musical notes, via the Internet. Shown here at the server side are encoding facility 58, mass storage facility 60, and encrypting for transport facility 56. The Internet facility proper 52 will eventually allow reception by client 54, that in its turn has re-encrypting facility 62 for subsequent storage in secure storage facility 64, and decrypting-decoding facility 66 for reproducing the audio content, that is again symbolized by musical notes. Both the server side and also the client side are assumed to be secure, for so establishing a secure connection therebetween. The client is assumed to be secure in the sense that any information residing therein or arriving from the outer world, is also secure.

In the context of FIG. 5, FIG. 6 illustrates a further advantageous feature of the present invention through a secure storage of protected data retrieved from an Internet 70. For secure local storing, the Trusted Application TA 74 claims more medium space 76 from the File System FS than actually needed, and will retrieve the sector addresses 78 of the space so claimed. Then, the sectors are clustered and the addresses of each cluster are combined with the key 72 received from the content provider to encrypt the data 80 for the associated cluster. Note that less than all available space in a cluster will actually be used, and superfluous space may be returned to the File System. FIG. 6 at right shows the seven sectors 1 through 7 through their original content (cf. FIG. 2a “40”), the cluster formed, and the totally claimed space.

The manipulation of the content is now restricted to what the Trusted Application will allow, which in turn will depend on the license that the user entity in question has. Content licensed to be played only a limited number of times may not be written to removable media. Content with a license for unlimited replay, but with a restricted copy license may only be written to media that have been provided with an identifier of the medium in question, which identifier will then be used in the encryption process. Depending on the specific type of copy license, at any particular time the content may be present on a single medium, or on a single device only, or on several ones of a limited set of media and/or devices. A copy can only be generated at the local source, the Trusted Application. Note that this Trusted Application will reside at the same system partition as the protected data, and both are bound to the same logical address space. A license to reproduce the content a single time on a certain other medium may be extracted only once from the original medium, but provided only that the original medium can be made unreadable for later access, such as by a “Burning TOC” procedure on a CD-R, in which procedure the TOC will be destroyed by operating the laser at a sufficiently high power rating.

1. A computer method for operating confidential data that are organized in finite-sized data chunks, said method comprising the steps of:
assigning to each said data chunk a particular logical address of a set of logical addresses;
storing each said data chunk at a respective unique physical address on a medium, whilst maintaining a predetermined relationship between said particular logical address and said unique physical address;
and executing a computer software program that accesses the chunks through said logical addresses;
said method being characterized by the following steps:
before said storing, encrypting a said data chunk through an encryption key that is at least co-based on an address assigned to said data chunk,
and after said reading, decrypting a said data chunk through usage of a decryption key as an inverse of the latter encryption key.

2. A method as claimed in claim 1, wherein said address is a physical address.

3. A method as claimed in claim 1, wherein said data chunk is encrypted through using a plurality of physical addresses in combination.

4. A method as claimed in claim 3, wherein said plurality of addresses are noncontiguous.

5. A method as claimed in claim 1, wherein said encryption key is co-based on an additional key provided by a further source entity.

6. A method as claimed in claim 1, wherein a limited number of copyings has been licensed, and furthermore rendering upon actuating said limited number an original version of the confidential data unreadable.

7. A method as claimed in claim 1, wherein said storing amends a natural sequence of chunks through skipping one or more and/or sequentially interchanging of one or more physically addressed locations.

8. A method as claimed in claim 1, wherein said storing applies a sparing mechanism whilst automatically associating an appropriate encryption key when assigning a substitute physical location to a particular data chunk.

9. A method as claimed in claim 1, wherein said chunks are uniform-sized.

10. A method as claimed in claim 1, and furthermore reading a representation of said predetermined relationship, checking occurrence of said physical addresses as being paired to associated logical addresses for conformance to said predetermined relationship as being read, and on the basis of an outcome of said checking, accepting or rejecting said instant medium as an authorized version or otherwise.

11. An apparatus for operating confidential data that are organized in finite-sized data chunks, said apparatus comprising:
assigning means for assigning to each said data chunk a particular logical address of a set of logical addresses;
storing means for storing each said data chunk at a respective unique physical address on a medium, whilst maintaining a predetermined relationship between said particular logical address and said unique physical address;
processing means for executing a computer software program that accesses said chunks through said logical addresses;
said apparatus being characterized by comprising:
encrypting means for before said storing, encrypting a said data chunk through an encryption key that is at least co-based on an address assigned to said data chunk,
decrypting means for after said reading, decrypting a said data chunk through usage of a decryption key as an inverse of the latter encryption key.

12. An apparatus as claimed in claim 11, wherein said address is a physical address.

13. An apparatus as claimed in claim 11, wherein said data chunk is encrypted through using a plurality of physical addresses.

14. An apparatus as claimed in claim 13, wherein said plurality of addresses are non-contiguous.

15. An apparatus as claimed in claim 11, wherein said encryption key is co-based on an additional key provided by a further source entity.

16. An apparatus as claimed in claim 11, wherein said storing amends a natural sequence of chunks through skipping one or more and/or sequentially interchanging of one or more physically addressed locations.

17. An apparatus as claimed in claim 11, wherein said storing applies a sparing mechanism whilst automatically associating an appropriate encryption key when assigning a substitute physical location to a particular data chunk.

18. An apparatus as claimed in claim 11, wherein said chunks are uniform-sized.

19. An encrypting apparatus arranged for application in a method as claimed in claim 1.

20. A decrypting apparatus arranged for application in a method as claimed in claim 1.

21. A data carrier carrying a protected set of data chunks for being used in a method as claimed in claim 1.
